(19) United States
(12) Patent Application Publication
(10) Pub. No.: US 2023/0231212 A1
(43) Pub. Date: Jul. 20, 2023

(54) CONTROL DEVICE FOR SECONDARY BATTERY AND CONTROL SYSTEM FOR SECONDARY BATTERY

(71) Applicant: TOYOTA JIDOSHA KABUSHIKI KAISHA, Toyota-shi (JP)

(72) Inventors: Kentaro SUZUKI, Kariya-shi (JP); Tomoya HAYASHI, Nagoya-shi (JP)

(73) Assignee: TOYOTA JIDOSHA KABUSHIKI KAISHA, Toyota-shi (JP)

(21) Appl. No.: 17/994,946

(22) Filed: Nov. 28, 2022

(30) Foreign Application Priority Data
Jan. 20, 2022 (JP) 2022-006982

(51) Int. Cl. H01M 10/48; H01M 10/633; H01M 10/613; H01M 10/625

(52) U.S. Cl. CPC H01M 10/484; H01M 10/486; H01M 10/613; H01M 10/625; H01M 10/633; H01M 2220/20

(57) ABSTRACT

A control device includes: a calculating portion configured to calculate an electrolytic solution passing amount based on a temperature history of a secondary battery; a determination portion configured to make the determination on a predetermined gas content based on one or more first thresholds and a ratio of the electrolytic solution passing amount to a free volume of a container in which the secondary battery is accommodated; and a controlling portion configured to form predetermined notification information when an affirmative determination is made on the predetermined gas content.

### CROSS-REFERENCE TO RELATED APPLICATION

This application claims priority to Japanese Patent Application No. 2022-006982 filed on Jan. 20, 2022, incorporated herein by reference in its entirety.

### BACKGROUND

### 1. Technical Field

The technology described in the present specification relates to a control device for a secondary battery and a control system for a secondary battery.

### 2. Description of Related Art

A secondary battery is provided in a vehicle such as an automobile so as to drive wheels or the like. The secondary battery is provided as a battery pack such that a plurality of secondary battery cells (hereinafter just referred to as cells) is accommodated in a container, for example. In such a secondary battery, electrolytic solution is sometimes promoted to be discharged (pass) through a seal material from each cell due to an increase in battery temperature. It is known that, due to the discharge of the electrolytic solution, the amount of the electrolytic solution in the cell decreases, so that the performance of the cell decreases or the seal material deteriorates. In view of this, as a technology to determine the deterioration state of a secondary battery, the following method is proposed (Japanese Unexamined Patent Application Publication No. 2016-72180 (JP 2016-72180 A)). That is, the deterioration of a battery is evaluated such that an electrolytic solution passing amount indicative of the amount of electrolytic solution lost from a cell is calculated based on the temperature history of the battery, and the deterioration of the battery is evaluated based on the electrolytic solution passing amount.

### SUMMARY

The permeation of electrolytic solution from a cell may cause accumulation of gas derived from the electrolytic solution inside a container in which a secondary battery is accommodated. Further, when the permeation amount of the electrolytic solution increases, the electrolytic solution remaining inside the secondary battery is reduced. This might cause a decrease in charge-discharge efficiency of the secondary battery or a decrease in cooling efficiency.

The present specification provides a technology to avoid or restrain a defect to be caused due to permeation of electrolytic solution, by use of an electrolytic solution passing amount to outside a cell.

A control device for a secondary battery to be described in the present specification includes a calculating portion, a determination portion, and a controlling portion. The calculating portion is configured to calculate an electrolytic solution passing amount based on a temperature history of the secondary battery. The determination portion is configured to make determination on a predetermined gas content based on a ratio of the electrolytic solution passing amount to a free volume of a container in which the secondary battery is accommodated and one or more first thresholds. The controlling portion is configured to form predetermined notification information when an affirmative determination is made on the predetermined gas content.

With the control device, at the time when a secondary battery is collected from a container of a battery pack or the like in which the secondary battery is accommodated, and the secondary battery is then disassembled and reused, for example, it is possible to acquire a gas content in the container in advance.

Since the electrolytic solution passing amount from the secondary battery or the ratio of the electrolytic solution passing amount to the free volume of the container in which the secondary battery is accommodated is highly related to the gas content inside the container, it is possible to acquire the gas content in the container with high accuracy.

Further, a control device for a secondary battery to be described in the present specification includes a calculation portion, a determination portion, and a controlling portion. The calculating portion is configured to calculate an electrolytic solution passing amount based on a temperature history of the secondary battery and to calculate an electrolytic solution residual amount of the secondary battery based on the electrolytic solution passing amount. The determination portion is configured to determine whether it is necessary to decrease an input-output amount of the secondary battery based on the electrolytic solution residual amount and one or more second thresholds. The controlling portion is configured to, when the determination portion determines that it is necessary to decrease the input-output amount, decrease the input-output amount of the secondary battery based on the electrolytic solution residual amount.

With the control device, it is possible to decrease the input-output amount of the secondary battery based on the electrolytic solution residual amount. Accordingly, it is possible to use the secondary battery in accordance with the battery performance of the secondary battery that may decrease as the electrolytic solution residual amount decreases, and it is also possible to restrain deterioration of the secondary battery.

Further, since the electrolytic solution residual amount in the secondary battery is highly related to the battery performance, the control device configured as such is effective for the effective use of the secondary battery and restraint of the deterioration of the secondary battery.

A control device for a secondary battery to be described in the present specification includes: a calculating portion configured to calculate an electrolytic solution passing amount based on the temperature history of the secondary battery; and a determination portion configured to determine whether it is necessary to increase a cooling work load to the secondary battery based on one or more third thresholds and an electrolytic solution residual amount to be calculated based on the electrolytic solution passing amount. Further, the control device includes a controlling portion configured to, when the determination portion determines that it is necessary to increase the cooling work load, increase the cooling work load based on the electrolytic solution residual amount.

With the controlling portion, it is possible to increase the cooling work load to the secondary battery as the electrolytic solution residual amount decreases. Accordingly, it is possible to cool the secondary battery by overcoming a decrease in cooling efficiency to the secondary battery that may decrease as the electrolytic solution residual amount decreases, and it is also possible to restrain deterioration of the secondary battery.

Further, since the electrolytic solution residual amount in the secondary battery is highly related to the cooling efficiency, it is possible to effectively cool the secondary battery and restrain the deterioration of the secondary battery.

A control system for a secondary battery to be described in the present specification includes the secondary battery and any of the above control devices.

With the control system, it is possible to avoid or restrain a defect to be caused due to an increase in the electrolytic solution passing amount in the secondary battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram to describe a control device for a secondary battery;

FIG. 2 is a view illustrating an example of a configuration of a battery pack;

FIG. 3 illustrates one example of a cell;

FIG. 4A is a view illustrating a change in an electrolytic solution residual amount in the secondary battery;

FIG. 4B is a view illustrating a change in the electrolytic solution residual amount in the secondary battery;

FIG. 4C is a view illustrating a change in the electrolytic solution residual amount in the secondary battery;

FIG. 5 is a flowchart illustrating an example of a secondary battery controlling process to be performed by an ECU;

FIG. 6 is a flowchart illustrating another example of the secondary battery controlling process to be performed by the ECU;

FIG. 7 is a flowchart illustrating another example of the secondary battery controlling process to be performed by the ECU;

FIG. 8 is a flowchart illustrating another example of the secondary battery controlling process to be performed by the ECU; and

FIG. 9 is a flowchart illustrating another example of the secondary battery controlling process to be performed by the ECU.

### DETAILED DESCRIPTION OF EMBODIMENTS

One aspect of the control device for the secondary battery to be described in the present specification is a control device that can make a notification about a predetermined gas content in terms of gas derived from electrolytic solution. When the controlling portion determines that the secondary battery is electrically disconnected, the controlling portion provides the notification information on the predetermined gas content. With such a configuration, it is possible to make a notification about the predetermined gas content only when necessary such as the time when the secondary battery is removed from a vehicle.

Further, in one aspect of the control device to be described in the present specification, the determination portion further determines whether it is necessary to decrease an input-output amount of the secondary battery based on one or more second thresholds and an electrolytic solution residual amount to be calculated based on the electrolytic solution passing amount. When the determination portion further determines that it is necessary to decrease the input-output amount, the controlling portion decreases the input-output amount of the secondary battery based on the electrolytic solution residual amount. With such a configuration, it is possible to effectively use the secondary battery in which the electrolytic solution is reduced and to restrain deterioration of the secondary battery.

Further, in one aspect of the control device, the determination portion further determines whether it is necessary to increase a cooling work load to the secondary battery based on the electrolytic solution residual amount and one or more third thresholds. When the determination portion further determines that it is necessary to increase the cooling work load, the controlling portion increases the cooling work load based on the electrolytic solution residual amount. With such a configuration, it is possible to effectively cool the secondary battery in which the electrolytic solution is reduced and to improve a battery life.

In these aspects, at least some of the one or more second thresholds are smaller than the one or more third thresholds. The use of the second thresholds is effective for the determination on whether it is necessary to decrease the input-output amount of the secondary battery.

Another aspect of a control device for a secondary battery to be described in the present specification includes: a calculating portion configured to calculate an electrolytic solution passing amount based on a temperature history of the secondary battery; a determination portion configured to determine whether it is necessary to decrease an input-output amount of the secondary battery based on one or more second thresholds and an electrolytic solution residual amount to be calculated based on the electrolytic solution passing amount; and a controlling portion configured to, when the determination portion determines that it is necessary to decrease the input-output amount, decrease the input-output amount of the secondary battery based on the electrolytic solution residual amount. With such a configuration, it is possible to effectively use the performance of the secondary battery and to restrain deterioration of the secondary battery.

Another aspect of a control device for a secondary battery to be described in the present specification includes: a calculating portion configured to calculate an electrolytic solution passing amount based on a temperature history of the secondary battery; a determination portion configured to determine whether it is necessary to increase a cooling work load to the secondary battery based on one or more third thresholds and an electrolytic solution residual amount to be calculated based on the electrolytic solution passing amount; and a controlling portion configured to, when the determination portion determines that it is necessary to increase the cooling work load, increase the cooling work load based on the electrolytic solution residual amount. With such a configuration, it is possible to effectively use the performance of the secondary battery and to restrain deterioration of the secondary battery.

One aspect of a control system for a secondary battery to be described in the present specification includes a secondary battery provided in a vehicle. The vehicle often uses a high-capacity secondary battery. Further, the high-capacity secondary battery is often used for a long period of time. Accordingly, it is significant to restrain or avoid a defect to be caused due to electrolytic solution passing through cells.

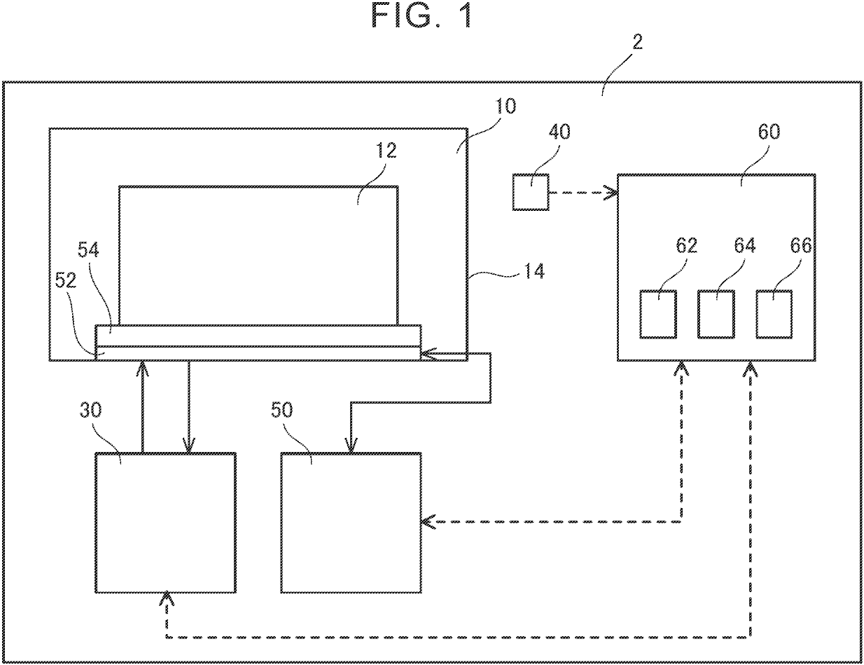

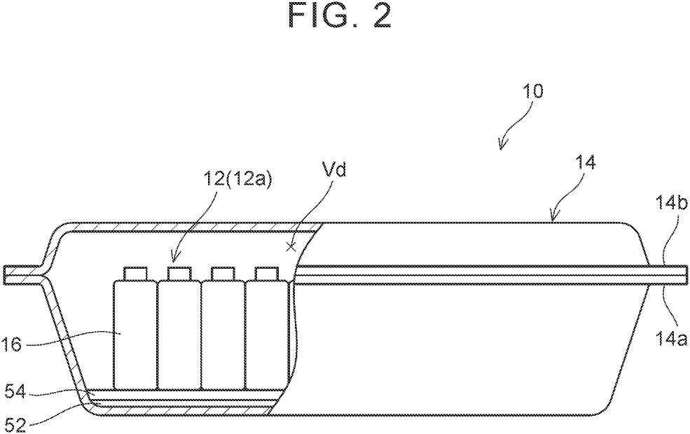

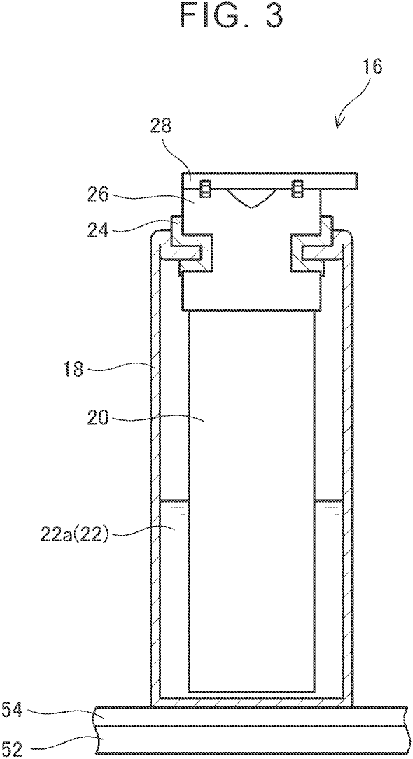

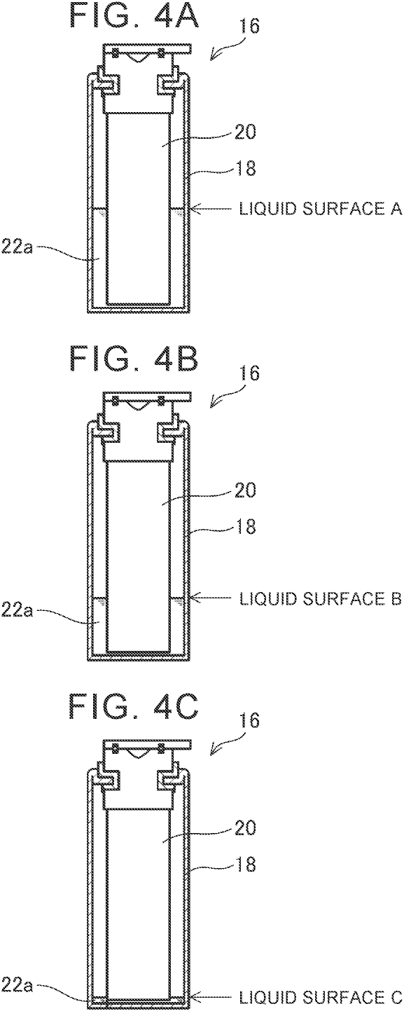

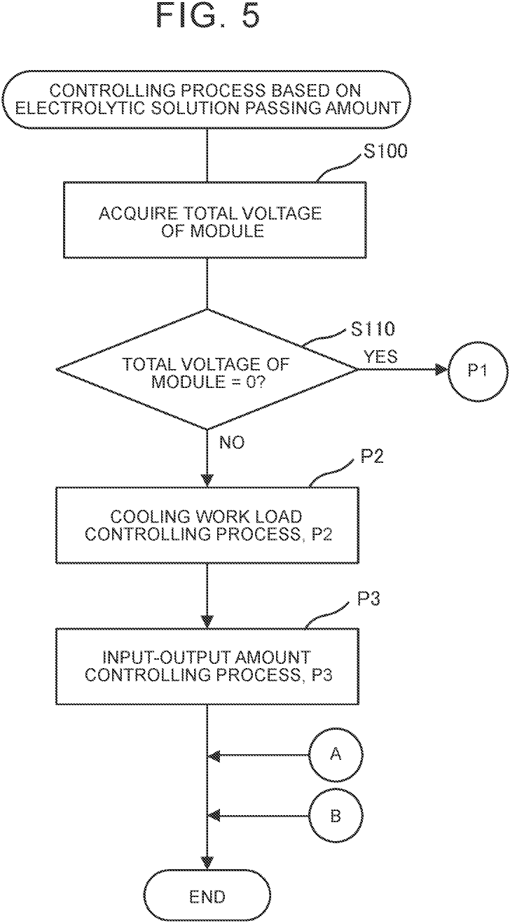

The following describes a control device for a secondary battery to be described in the present specification and a secondary battery controlling process to be performed by the control device, with reference to the drawings appropriately. FIG. 1 illustrates an example of a configuration of a vehicle equipped with a secondary battery and a control device for the secondary battery to be described in the present specification. FIG. 2 is a view illustrating an example of a configuration of a battery pack. FIG. 3 illustrates an example of a cell. FIGS. 4A to 4C illustrate the state of excessive electrolytic solution in the cell. FIGS. 5 to 9 each illustrate an example of the secondary battery controlling process.

A vehicle 2 is a so-called hybrid electric vehicle (HEV) including an engine (not illustrated). Note that, in addition to this, the vehicle 2 may be a plug-in hybrid electric vehicle (PHEV), a battery electric vehicle (BEV), a fuel cell electric vehicle (FCEV), or the like. As illustrated in FIG. 1, the vehicle 2 includes a secondary battery pack (hereinafter just referred to as a battery pack) 10, a load 30, a sensor 40, a cooling circuit 50, and an electronic control unit (ECU) 60. For convenience of description, the following describes the load 30, the sensor 40, and the cooling circuit 50 first.

### Load

The load 30 includes a drive motor configured to generate a driving force to drive the vehicle 2 by use of electric power from the battery pack 10. Further, the load 30 charges cells 16 of the battery pack 10 with regenerative electric power from a traction motor.

### Sensor

The sensor 40 detects the temperature of secondary battery cells (cells) 16 inside the battery pack 10. The configuration of the sensor 40 is not limited in particular, but, for example, one sensor 40 is provided for a set of several cells 16, so that a plurality of sensors 40 is provided altogether. Further, each of the sensors 40 detects a voltage, a current, or the like of its corresponding cell in addition to the temperature of the corresponding cell, for example.

### Cooling Circuit

The cooling circuit 50 cools at least the battery pack 10 and can also cool various elements in the vehicle 2. As illustrated in FIG. 2, the cooling circuit 50 is not limited in particular but includes a passage 52 through which refrigerant such as water is transferred to the battery pack 10, and a heat conduction member 54 configured to remove heat by the refrigerant. The heat conduction member 54 is a member that has a relatively high heat conductance (coefficient of thermal conductivity).

The heat conduction member 54 is disposed inside a container 14 of the battery pack 10 (described later). The heat conduction member 54 is disposed such that the heat conduction member 54 makes close contact with the lower face of a battery module 12, for example. Part of the passage 52 is disposed inside the container 14 such that the part of the passage 52 makes close contact with the heat conduction member 54 in a heat exchangeable manner with the heat conduction member 54. In addition to this, the cooling circuit 50 includes an electric pump, a radiator, a cooling fan, a chiller, a cooler, a change valve, and so on, so that the cooling circuit 50 cools the battery module 12 accommodated in the container 14 of the battery pack 10 by the refrigerant with a controlled temperature and a controlled flow rate.

### Battery Pack

The battery pack 10 supplies electric power to the load 30 such as a drive motor configured to generate a driving force for driving wheels of the vehicle 2 and receives electric power supplied from the load 30. The battery pack 10 is accommodated in a space sectioned by a floor panel below a vehicle cabin of the vehicle 2, for example.

As illustrated in FIG. 2, the battery pack 10 includes the battery module (hereinafter just referred to as a module) 12 and the container 14 in which the module 12 is accommodated. The module 12 includes a plurality of submodules 12a, and each of the submodules 12a is constituted by a plurality of cells 16. The submodules 12a may be accommodated in a case or the like. A secondary battery constituting the cell 16 is a secondary battery such as a lithium-ion battery or a nickel-metal hydride battery, for example, but is not limited in particular.

The container 14 is constituted by a lower case 14a and an upper cover 14b, and the module 12 is accommodated in the container 14 with a high airtightness. As has been described already, the heat conduction member 54 and the passage 52 are disposed on a bottom portion inside the container 14. Further, the battery pack 10 has a predetermined space (dead space) that is not occupied by the module 12 and other component parts inside the container 14, and its spatial volume (free volume) is Vd.

FIG. 3 illustrates a sectional view of the cell 16 as an example of the cell 16. The cell 16 includes, for example, a housing 18, an electrode group 20, and electrolytic solution 22. A seal material 24 made of resin or the like is provided in the upper part of the housing 18. Further, the cell 16 includes a gas release vent, a current interrupt device (CID), and so on (not illustrated).

Inside the housing 18, the electrode group 20 and the electrolytic solution 22 are accommodated. The electrode group 20 is electrically connected to a collector terminal 26. Further, the collector terminal 26 is electrically connected to an external terminal 28 via a bus bar, for example.

The electrode group 20 is, for example, a winding-type electrode group. The electrode group 20 is configured such that a separator, a positive electrode, a separator, and a negative electrode are laminated in this order to form a belt-shaped laminated body, and further, the laminated body is wounded. Note that the electrode group 20 is not limited to the winding-type electrode group and may be well-known other electrode groups such as a laminate-type electrode group, for example.

The electrolytic solution 22 permeates into the electrode group 20. Excessive electrolytic solution 22a that does not permeate into the electrode group 20 is present inside the housing 18 and is accumulated outside the electrode group 20. The electrolytic solution 22 contains lithium salt and solvent, and the solvent is organic solvent such as N-methylpyrrolidon, ion exchanged water, or the like.

Here, with reference to FIGS. 4A to 4C, the state of the electrolytic solution 22 in the cell 16 will be described. As illustrated in FIG. 4A, in the beginning of mounting of the cell 16, the electrolytic solution 22 is accumulated inside the housing 18 and reaches a liquid surface A, for example. The electrolytic solution 22 permeates into the electrode group 20, and the remaining of the electrolytic solution 22 that is accumulated outside the electrode group 20 is the excessive electrolytic solution 22a. In this state, the electrode group 20 is sufficiently impregnated with the electrolytic solution 22, so that battery performance is secured. The excessive electrolytic solution 22a is prepared for the purpose of cooling the module 12 by heat exchange with the passage 52 and the heat conduction member 54 outside the housing 18 and for the purpose of forming a solid electrolyte interphase (SEI) coating to be formed in a negative electrode under an operating environment or the like.

The electrolytic solution 22 gradually passes through the cell 16 to its outside (is gradually discharged to outside the cell 16) by vaporization, reliquefaction in the seal material 24, and a capillary phenomenon. Hereby, as illustrated in FIG. 4B, the electrolytic solution 22 is reduced, and the liquid surface of the excessive electrolytic solution 22a decreases to a liquid surface B, for example. Even in this state, the electrode group 20 is sufficiently impregnated with the electrolytic solution 22, so that the battery performance itself is secured. In the meantime, the height of the liquid surface of the excessive electrolytic solution 22a decreases. Accordingly, although the electrode group 20 exchanges heat with the excessive electrolytic solution 22a, the rate of heat-exchange through air increases, so that thermal resistance largely tends to increase.

Further, as the electrolytic solution 22 passes through the cell 16 more, the electrolytic solution 22 is further reduced, as illustrated in FIG. 4C, and the liquid surface of the excessive electrolytic solution 22a decreases to a liquid surface C, for example, so that the excessive electrolytic solution 22a is depleted. Note that, in this state, the electrode group 20 is hard to be sufficiently impregnated with the electrolytic solution 22, thereby resulting in that the battery performance starts to decrease, and it is difficult to form the SEI. Further, since the excessive electrolytic solution 22a is depleted, the heat exchange between the electrode group 20 and the passage 52 or the like is mainly performed through the air, so that the thermal resistance further increases.

As the electrolytic solution 22 passes through the cell 16 still further, the electrolytic solution 22 inside the electrode group 20 starts to be depleted, so that the cooling efficiency or the charging efficiency of the electrode group 20 further decreases.

### ECU

As illustrated in FIG. 1, the ECU 60 controls a system including the engine, the load (motor) 30, the cooling circuit 50, and the module 12 in the vehicle 2 as a hybrid electric vehicle. The ECU 60 is configured as a so-called computer including at least one CPU and a memory. The ECU 60 acquires changes in the temperature of the cell 16 over time from the sensor 40, that is, the ECU 60 acquires the temperature of the cell 16 as a temperature history from the sensor 40. The ECU 60 acquires, as the temperature history, a maximum temperature or the like at predetermined time intervals (e.g., every 10 minutes), for example, and stores the temperature history in the memory in the ECU 60. The ECU 60 acquires the temperature history from the sensor 40 and stores the temperature history during the driving of the vehicle 2 and during the stop of the vehicle 2. The ECU 60 is an example of a control device described in the present specification.

The ECU 60 includes, for example, a calculating portion 62, a determination portion 64, and a controlling portion 66 as functional portions to be implemented by causing a processor stored in the memory to work on the CPU.

### Calculating Portion

The calculating portion 62 calculates an electrolytic solution passing amount Me (mg) in the cell 16 based on a relational expression between the temperature of the cell 16 and the passing speed of the electrolytic solution 22 from the cell 16, and a battery-temperature history received from the sensor 40. The relational expression is acquired and stored in the memory in advance.

A specific calculation method is described in JP 2016-72180 A. The relational expression between a passing speed ka of the electrolytic solution 22 and a battery temperature TB is found in advance by a bench test or the like, for example. The relationship between a logarithmic value (a logarithmic value such as a common logarithm or a natural logarithm) of the passing speed ka of the electrolytic solution 22 and an inverse of the battery temperature TB can be expressed by a linear-function equation. Accordingly, by finding combinations of the passing speed ka of the electrolytic solution and the battery temperature TB at two points or more by the bench test or the like, a slope and an intercept for the linear-function equation are calculated. Based on the linear-function equation obtained by the slope and the intercept thus calculated, a logarithmic value of the passing speed ka of the electrolytic solution to the temperature TB can be calculated. As the battery temperature TB is larger (the inverse of the battery temperature TB is smaller), the passing speed ka (the logarithmic value of the passing speed ka) of the electrolytic solution is larger.

Further, the electrolytic solution passing amount Me is calculated based on a value obtained by multiplying the passing speed ka of the electrolytic solution 22 at the temperature of the cell 16 and a dwell time t at the temperature. More specifically, the electrolytic solution passing amount Me is calculated in accordance with the following formula: Electrolytic solution passing amount Me = Σ{t(TB(m)) × ka(TB(m))}. Note that m indicates the number of histories. The above calculation is performed on all the cells 16, so that the electrolytic solution passing amount Me of the whole module 12 is calculated. The following description is made by use of the electrolytic solution passing amount Me (mg) of the whole module 12.

### Determination Portion

The determination portion 64 makes the determination on an electrolytic-solution-derived gas content (concentration) in the container 14 of the battery pack 10 by use of a ratio R of the electrolytic solution passing amount Me to a spatial volume (a free volume) Vd (L) of a dead space that is not occupied by constituents including the module 12 in the container 14 of the battery pack 10. A threshold K to determine the gas content is set based on a determination content in advance. The threshold K is set in terms of the ratio. The threshold may be a single threshold or may be a plurality of thresholds based on the gas content. In a case where a single threshold is set, the single threshold is set to a gas content based on which it is possible to determine that gas derived from the electrolytic solution is detectable by a gas sensor or the like at the time when the container 14 is opened, for example.

Further, in a case where a plurality of thresholds K is set, for example, thresholds K1, K2, K3, and so on are set in accordance with the gas content appropriately. The thresholds K, K1, and so on are examples of a first threshold described in the present specification.

Note that, since the spatial volume Vd of the dead space in the battery pack 10 is determined in advance, it is also possible to make the determination based on a threshold defined by use of the electrolytic solution passing amount Me.

Further, the determination portion 64 determines whether it is necessary to increase a cooling work load to the module 12 by use of an electrolytic solution residual amount Mer (mg) that is a difference between an initial electrolytic solution amount Me0 and the electrolytic solution passing amount Me. A threshold to determine whether it is necessary to increase the cooling work load is set based on a determination content in advance. The threshold is set in terms of the electrolytic solution residual amount. A single threshold L may be set, or a plurality of thresholds L may be set in accordance with how much the cooling work load is increased. In a case where a single threshold L is set, the single threshold L is set to an electrolytic solution residual amount corresponding to a timing to start to increase the cooling work load to the module 12, for example. For example, the threshold L is set to an electrolytic solution residual amount at which the excessive electrolytic solution 22a is in a slightly reduced state (a state where the excessive electrolytic solution is depleted in the cell 16 (e.g., an intermediate level between the states illustrated in FIGS. 4A, 4B)).

Further, for example, in a case where a plurality of thresholds L is set, they are set in advance based on the necessity to increase the cooling work load to the module 12 in the course where the electrolytic solution is further reduced, in addition to the single threshold L (also referred to as L1). For example, a threshold L2 corresponding to the state illustrated in FIG. 4B, a threshold L3 corresponding to the state illustrated in FIG. 4C where the electrolytic solution is further depleted, and so on are set appropriately. Note that the thresholds L, L1, and so on are examples of a third threshold described in the present specification.

Note that, since the initial electrolytic solution amount Me0 in the cell 16 is determined in advance, it is also possible to determine whether it is necessary to increase the cooling work load to the module 12, based on a threshold defined by the electrolytic solution passing amount Me.

Further, the determination portion 64 determines whether it is necessary to decrease an input-output amount of the module 12 by use of the acquired electrolytic solution residual amount Mer. A threshold to determine whether it is necessary to decrease the input-output amount is set based on a determination content in advance. The threshold is set in terms of the electrolytic solution residual amount. The threshold M may be a single threshold or may be a plurality of thresholds set based on how much the input-output amount is decreased. In a case where a single threshold M is set, the single threshold M is set to an electrolytic solution residual amount corresponding to a timing to start to decrease the input-output amount of the module 12, for example. For example, the single threshold L is set to an electrolytic solution residual amount at which the excessive electrolytic solution 22a is zero (a state where the excessive electrolytic solution is depleted in the cell 16 (e.g., the state illustrated in FIG. 4C)). Further, in a case where a plurality of thresholds M is set, for example, they are set in advance based on the necessity to restrict the input-output amount of the module 12 in the course where the electrolytic solution is further reduced. For example, a threshold M1 corresponding to the state illustrated in FIG. 4C, thresholds M2, M3 based on which it is determined to be necessary to increase a reduction level in the input-output amount due to the electrolytic solution being further depleted, and so on are set appropriately. Note that the thresholds M, M1, and so on are examples of a second threshold described in the present specification. Note that, since the initial electrolytic solution amount Me0 in the cell 16 is determined in advance, it is also possible to determine whether it is necessary to decrease the input-output amount, based on a threshold defined by the electrolytic solution passing amount Me.

In a case where the determination is made based on the electrolytic solution residual amount Mer, generally, the threshold M for the input-output amount is smaller than the threshold L for the cooling work load. This is because the necessity to decrease the input-output amount is caused in a state where the electrolytic solution residual amount Mer is further smaller (e.g., more depleted) than that in a case where the necessity to increase the cooling work load is caused. Accordingly, in a case where the thresholds M1 to M3 and so on are used as for the input-output amount, it is useful to set at least some of the thresholds M1 to M3 and so on to be smaller than all possible thresholds L. The setting of values for such thresholds suits the electrolytic solution residual amount Mer and inconvenient actual circumstances caused by the electrolytic solution residual amount Mer, and this allows a reasonable control.

### Controlling Portion

The controlling portion 66 forms notification information on the gas content based on the determination by the determination portion 64 on the gas content. The notification information is associated in advance with a threshold based on which a predetermined gas content is affirmed. The controlling portion 66 stores, for example, such notification information in the memory and outputs the notification information as a control signal to cause a display panel of the vehicle 2 to display the notification information and/or to cause a speaker or the like to output a warning beep.

Further, the controlling portion 66 outputs, to the cooling circuit 50, a control command to increase the cooling work load to the module 12 based on the determination by the determination portion 64 on the increase in the cooling work load to the module 12. A degree of the increase or the like is associated in advance with the threshold used as a reference for the determination. The controlling portion 66 defines a refrigerant temperature and a flow rate in accordance with the temperature of the module 12 at that point and a temperature to which the temperature of the module 12 is to be controlled. As a result, the controlling portion 66 outputs, to the pump or the chiller of the cooling circuit 50, a control signal to increase an output from the pump or to enhance cooling in the chiller, for example.

Further, the controlling portion 66 causes the module 12 to decrease the upper limit of input power (charging power) and the upper limit of output power (charging power), based on the determination by the determination portion 64 on the decrease in the input-output amount of the module 12. A degree of the decrease or the like is associated in advance with the threshold used as a reference for the determination. The controlling portion 66 outputs, to a motor generator electronic control unit (MG-ECU) or the like configured to define the input-output amount from the motor to the module 12, a control signal to decrease the upper limit of the input power and the upper limit of the output power in accordance with the SOC (%) of the module 12 that is calculated separately.

With reference to FIGS. 5 to 8, next will be described a process P1 of making the determination on a gas content of gas derived from the electrolytic solution based on the electrolytic solution passing amount Me or the like, and processes P2, P3 of controlling the cooling work load to the module 12 and the input-output amount of the module 12, respectively. The processes P1, P2, P3 are performed by the ECU 60. The procedure illustrated in FIG. 5 is an example of a process about a gas content and the module 12 by use of the electrolytic solution passing amount Me, the process being performed by the CPU of the ECU 60.

Note that, in the following processes, as the threshold for the gas content, the threshold K2 is set as a concentration (a predetermined threshold) at which gas may be detected by a gas sensor or the like at the time when the container 14 is opened. Further, as the threshold for the cooling work load to the module 12, the thresholds L1 to L3 are set in accordance with the electrolytic solution residual amount. The threshold L1 is an initial value and is updated to L2 and L3 sequentially as needed in the process. Further, as the threshold for the input-output amount of the module 12, the thresholds M1 to M3 are set in accordance with the electrolytic solution residual amount. The threshold M1 is an initial value and is updated to M2 and M3 sequentially as needed in the process.

### Gas Content Determination Process

The CPU acquires a total voltage of the module 12 from the sensor 40 (step S100). Subsequently, the CPU determines whether the total voltage is zero or not (step S110). When the total voltage of the module 12 is zero, the CPU determines that the battery pack 10 including the module 12 is taken out of the vehicle 2, and the CPU shifts to a gas content determination process P1.

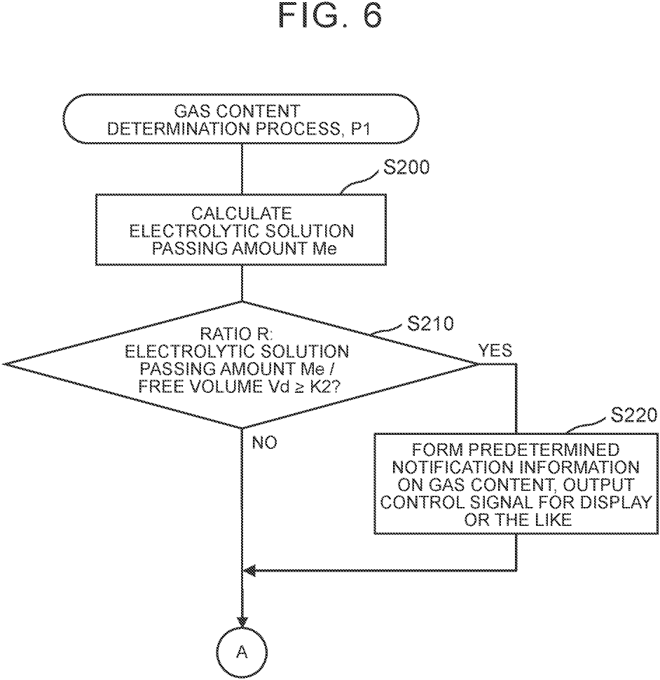

As illustrated in FIG. 6, in the gas content determination process P1, the CPU calculates the electrolytic solution passing amount Me of the module 12 from the acquired temperature history of the cell 16 and the relational expression between the temperature of the cell 16 and the passing speed of the electrolytic solution, the relational expression being acquired in advance (step S200).

Subsequently, the CPU compares the ratio R of the electrolytic solution passing amount Me to the spatial volume Vd of the dead space of the battery pack 10 with the threshold K2 so as to determine whether the ratio R is equal to or more than the threshold K2 (step S210). When the ratio R is equal to or more than the threshold K2, the CPU determines that gas derived from the electrolytic solution has a predetermined concentration at which the gas may be detected by a gas sensor or the like at the time when the container 14 is opened. The CPU forms predetermined notification information by providing a notification on the threshold for the gas content and detection possibility by the sensor or the like, and the CPU outputs, to a display device of an instrument panel or the like of the vehicle 2 and the speaker, control signals to cause the display device to display the notification information and to cause the speaker to output a warning beep (step S220). Here, the CPU ends the process P1 and also ends the whole process. When the ratio R is less than the threshold K2, the CPU determines that the notification should not be provided, and the CPU ends the process P1 and the whole process.

In the meantime, when the total voltage of the module 12 is not zero, the CPU determines that the battery pack 10 is provided in the vehicle 2, and the CPU shifts to a cooling work load controlling process P2.

### Cooling Work Load Controlling Process

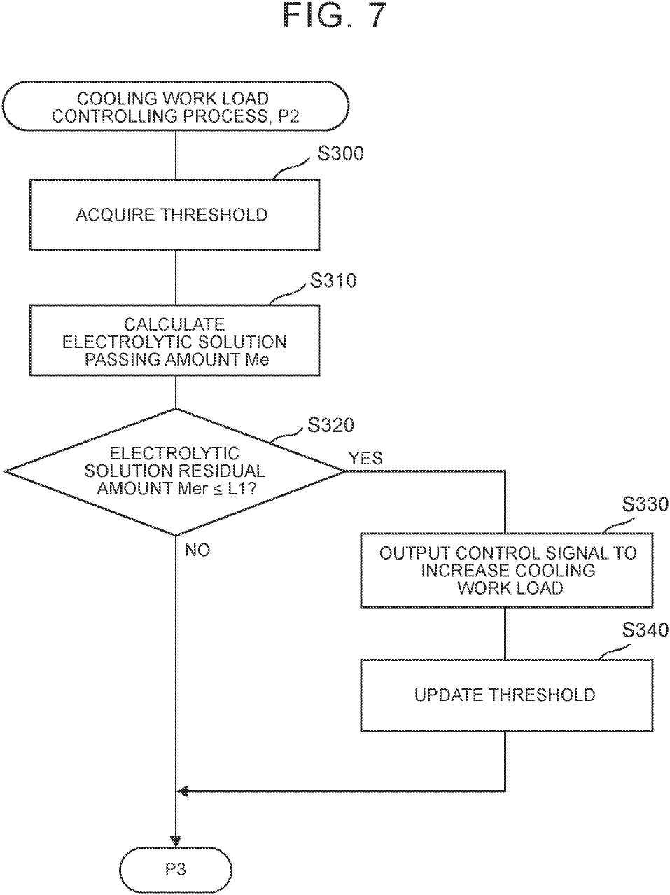

The cooling work load controlling process P2 is illustrated in FIG. 7. As illustrated in FIG. 7, the CPU first acquires a threshold to determine whether the cooling work load is to be increased (step S300). The threshold is prepared in the memory in the ECU 60. In a threshold initial state that is not updated, the threshold L1 is acquired.

Subsequently, the CPU calculates the electrolytic solution passing amount Me similarly to the gas content determination process (step S310).

The CPU determines whether the electrolytic solution residual amount Mer is equal to or less than the threshold L1, by comparing the electrolytic solution residual amount Mer as a difference between the electrolytic solution passing amount Me and the initial electrolytic solution amount Me0 with the threshold L1 (step S320). When the electrolytic solution residual amount Mer is more than the threshold L1, the CPU determines that it is not necessary to increase the cooling work load. Here, the CPU shifts to a subsequent input-output amount controlling process P3.

When the electrolytic solution residual amount Mer is equal to or less than the threshold L1, the CPU determines that it is necessary to increase the cooling work load, and the CPU outputs, to the chiller or the pump of the cooling circuit 50, a control signal including a content to increase the cooling work load (the refrigerant temperature and/or the flow rate) to the module 12 (step S330). More specifically, for example, by referring to a current cell temperature from the sensor 40, the CPU outputs a control signal to increase the cooling work load such that the cell temperature reaches a target cell temperature.

Subsequently, the CPU updates the threshold L1 to the threshold L2 so as to determine whether it is necessary to further increase the cooling work load (step S340), and then, the CPU ends the process P2 and shifts to the input-output amount controlling process P3 for the module 12.

### Input-Output Amount Controlling Process

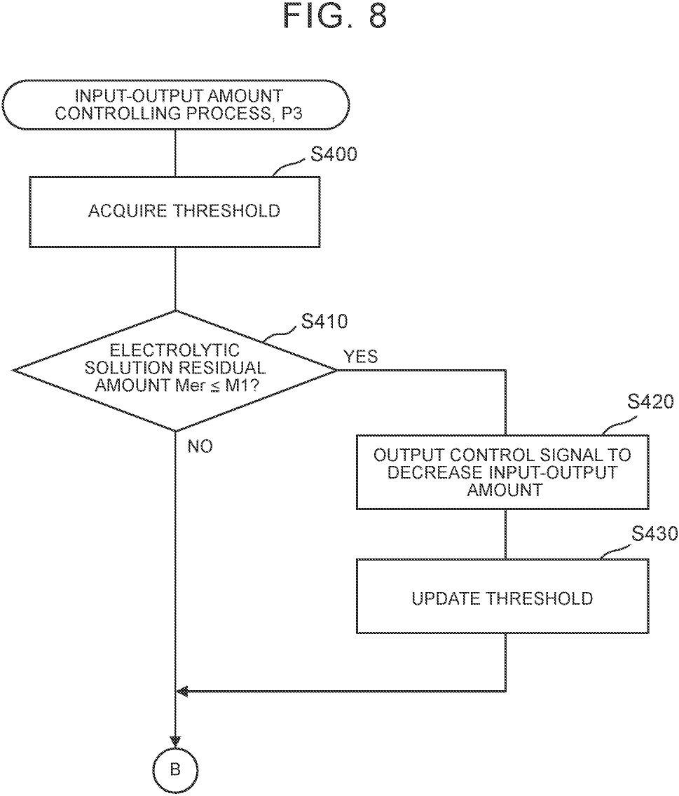

The input-output amount controlling process P3 is illustrated in FIG. 8. As illustrated in FIG. 8, the CPU first acquires a threshold to determine whether the input-output amount is to be decreased (step 400). The threshold is prepared in the memory in the ECU 60. In a threshold initial state that is not updated, the threshold M1 is acquired.

Subsequently, the CPU determines whether the electrolytic solution residual amount Mer is equal to or less than the threshold M1, by comparing the electrolytic solution residual amount Mer with the threshold M1 (step S410). When the electrolytic solution residual amount Mer exceeds the threshold M1, the CPU determines that it is not necessary to decrease the input-output amount of the module 12. Here, the CPU ends the process P3 and also ends the series of processes.

When the electrolytic solution residual amount Mer is equal to or less than the threshold M1, the CPU determines that it is necessary to decrease the input-output amount of the module 12, and the CPU outputs a control signal indicative of a content to decrease the input-output amount of the module 12 (in accordance with the SOC (%)) (step S420). More specifically, for example, the CPU acquires the SOC (%) of the module 12 and outputs, to the MG-ECU, control signals to decrease a maximum value of input power and a maximum value of output power in accordance with the SOC (%), respectively.

Subsequently, the CPU updates the threshold M1 to the threshold M2 so as to determine whether it is necessary to further decrease the input-output amount (step S430). Here, the CPU ends the process P3 and also ends the series of processes.

The CPU performs the series of controlling processes based on the electrolytic solution passing amount Me at given time intervals.

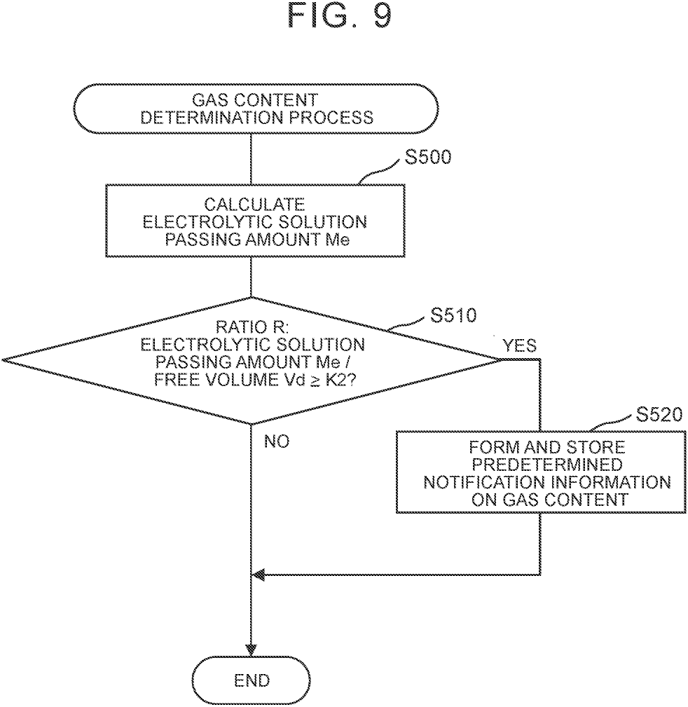

Note that, in the above gas content determination process, the CPU determines whether the total voltage of the module 12 is zero, and only when the battery pack 10 is removed from the vehicle 2, the CPU performs the process. However, the present disclosure is not limited to this. For example, as illustrated in FIG. 9, the CPU may perform the gas content determination process regardless of whether the battery pack 10 is removed or not, and when the CPU determines that there is a predetermined notification content about the gas content, the CPU may form gas content notification information and store it in the memory (steps S500 to S520). Separately, in a gas content notification process to be performed when the total voltage of the battery pack 10 is zero, the CPU may refer to whether gas content notification information is present or not, and when the gas content notification information is present, the CPU may clearly exhibit the notification content by display or by a warning beep.

With the above process, it is possible to estimate the state of the electrolytic solution 22 by use of the electrolytic solution passing amount Me even without opening the battery pack 10. Accordingly, it is possible to contactlessly and easily find, in advance, the content of gas to be accumulated in the container 14 when the electrolytic solution 22 passes through the cell 16 to its outside, and it is also possible to avoid or restrain a decrease in the efficiency of the cooling work load of the module 12 and a decrease in the performance. As a result, it is possible to restrain deterioration of the module 12 and to improve a battery life. For example, with these processes, even in a case where the module 12 is used for a long period of time and/or highly frequently, it is possible to easily determine stability or a problem of the battery pack 10 and the module 12 without opening the battery pack 10.

The gas content in the container 14 based on the ratio R or the electrolytic solution passing amount Me is highly related to gas detection at the time when the container 14 is opened, and therefore, by using them as indices, it is possible to acquire whether gas is detected, with high accuracy.

Further, the electrolytic solution passing amount Me or the electrolytic solution residual amount Mer is highly related to the cooling efficiency of the module 12. Accordingly, by controlling the cooling work load by using them as indices, the module 12 can be cooled off effectively and immediately, thereby making it possible to maintain the performance of the module 12 or to extend the life of the module 12.

Further, the electrolytic solution passing amount Me or the electrolytic solution residual amount Mer is highly related to the performance of the module 12. Accordingly, by controlling the input-output amount of the module 12 by using them as indices, it is possible to protect the battery and extend the battery life even when the performance of the module 12 decreases.

In the control device described above, the gas content determination process, the cooling work load controlling process, and the input-output amount controlling process are performed as a series of processes. However, the present disclosure is not limited to this. These processes may be performed individually, the gas content determination process and the input-output amount controlling process may be performed in combination, the gas content determination process and the cooling work load controlling process may be performed in combination, or the input-output amount controlling process and the cooling work load controlling process may be performed in combination. Further, the order to perform the processes is also not limited particularly.

In the control device described above, the module 12 is provided in the vehicle 2 as a hybrid electric vehicle, and the module 12 is charged with regenerative electric power from the load (motor) 30. However, the present disclosure is not limited to this. For example, the module 12 may be charged by an external charging device, equipment, or the like other than the motor, or the module 12 may not be necessarily a module for a vehicle and may be a stationary module 12.

The cooling circuit 50 in the control device described above is configured such that the passage 52 and the heat conduction member 54 of the cooling circuit 50 are provided inside the container 14. However, the present disclosure is not limited to this. The cooling circuit 50 may perform cooling such that the heat conduction member 54 is provided inside the container 14, and the passage 52 and an additional heat conduction member 54 are provided outside the bottom portion of the container 14. Further, the module 12 can be cooled by various cooling circuits applied to the battery pack 10 and the module 12. For example, the various cooling circuits include an air-cooling system such as natural air-cooling or forced air-cooling, a radiator, an air conditioner, various hybrid-type water (coolant) cooling systems by a radiator and an air conditioner in combination, a direct cooling system by refrigerant, a coolant immersion system, and the like.

In the control device described above, the cooling work load is increased for the whole module 12. However, the present disclosure is not limited to such a configuration. The cooling work load may be increased only for some submodules 12a based on an electrolytic solution passing amount of one or more submodules 12a to be calculated based on an electrolytic solution passing amount based on the temperature histories of corresponding cells 16 that are acquired from the sensor 40. Similarly, the input-output amount is decreased for the whole module 12, but the present disclosure is not limited to this. The input-output amount may be decreased only for some of the submodules 12a.

In the control device described above, the decrease in the input-output amount of the module 12 is controlled in terms of the electric power amount, but the present disclosure is not limited to this. The input-output amount of the module 12 may be controlled in terms of an input current and an output current, or the like of the module 12.

The above description is made by use of the terms “equal to or more than,” “equal to or less than,” “more than,” and “less than” in terms of making the determination based on the thresholds. However, the present disclosure is not limited to this. An appropriate comparison determination can be performed in accordance with the indices to be used (the electrolytic solution passing amount Me, the ratio R, the electrolytic solution residual amount Mer) or values of the thresholds.

The above description deals with the embodiment of the control device of this disclosure, but the above description includes embodiments of a control system for a secondary battery that includes the control device and a battery pack, and an embodiment of a control method for the secondary battery. The above modifications are also applied to the control system and the control method.

The specific example of the technology disclosed in the present specification has been described in detail. However, the example is for illustration only, and does not limit the scope of the claims. The technology described in the scope of the claims includes the foregoing example with various modifications and changes. Each of and various combinations of the technical elements described in the present specification or the drawings achieve a technical usefulness, and the technical elements are not limited to the combination stated in the claims at the time of filing. The technology described in the present specification or the drawings can achieve a plurality of objects at the same time and has a technical usability by achieving one of those objects.

What is claimed is:

1. A control device for a secondary battery, the control device comprising:
a calculating portion configured to calculate an electrolytic solution passing amount based on a temperature history of the secondary battery;
a determination portion configured to make determination on a predetermined gas content based on a ratio of the electrolytic solution passing amount to a free volume of a container in which the secondary battery is accommodated and one or more first thresholds; and
a controlling portion configured to form predetermined notification information when an affirmative determination is made on the predetermined gas content.

2. The control device according to claim 1, wherein, when the controlling portion determines that the secondary battery is electrically disconnected, the controlling portion provides the notification information.

3. The control device according to claim 1, wherein:
the calculating portion further calculates an electrolytic solution residual amount in the secondary battery based on the electrolytic solution passing amount;
the determination portion further determines whether it is necessary to decrease an input-output amount of the secondary battery based on the electrolytic solution residual amount and one or more second thresholds; and
when the determination portion further determines that it is necessary to decrease the input-output amount, the controlling portion decreases the input-output amount of the secondary battery based on the electrolytic solution residual amount.

4. The control device according to claim 3, wherein:
the determination portion further determines whether it is necessary to increase a cooling work load to the secondary battery based on the electrolytic solution residual amount and one or more third thresholds; and
when the determination portion further determines that it is necessary to increase the cooling work load, the controlling portion increases the cooling work load based on the electrolytic solution residual amount.

5. The control device according to claim 3, wherein at least some of the one or more second thresholds are smaller than the one or more third thresholds.

6. The control device according to claim 1, wherein the secondary battery is provided in a vehicle.

7. A control system for a secondary battery, the control system comprising:
the secondary battery; and
the control device according to claim 1, the control device being configured to control the secondary battery.

8. The control system according to claim 7, wherein the control system is a control system for a secondary battery provided in a vehicle.

9. A control device for a secondary battery, the control device comprising:
a calculating portion configured to calculate an electrolytic solution passing amount based on a temperature history of the secondary battery and to calculate an electrolytic solution residual amount of the secondary battery based on the electrolytic solution passing amount;
a determination portion configured to determine whether it is necessary to decrease an input-output amount of the secondary battery based on the electrolytic solution residual amount and one or more second thresholds; and
a controlling portion configured to, when the determination portion determines that it is necessary to decrease the input-output amount, decrease the input-output amount of the secondary battery based on the electrolytic solution residual amount.

10. The control device according to claim 9, wherein:
the determination portion further determines whether it is necessary to increase a cooling work load to the secondary battery based on the electrolytic solution residual amount and one or more third thresholds; and
when the determination portion determines that it is necessary to increase the cooling work load, the controlling portion further increases the cooling work load based on the electrolytic solution residual amount.

11. The control device according to claim 9, wherein the secondary battery is provided in a vehicle.
